(19) United States
(12) Patent Application Publication
(10) Pub. No.: US 2023/0098334 A1
(43) Pub. Date: Mar. 30, 2023

(54) THIOLATED CHITOSAN AND PREPARATION METHOD THEREOF

(71) Applicant: Hangzhou Singclean Medical Products Co., Ltd, Hangzhou (CN)

(72) Inventors: Feifei Wu, Hangzhou (CN); Zhongyi Chen, Hangzhou (CN); Wanjun Jiang, Hangzhou (CN); Jie Li, Hangzhou (CN); Shitu Ma, Hangzhou (CN); Mengjun Hu, Hangzhou (CN)

(21) Appl. No.: 17/681,991

(22) Filed: Feb. 28, 2022

(30) Foreign Application Priority Data
Sep. 24, 2021 (CN) 202111118987.3

(51) Int. Cl. C08B 37/08

(52) U.S. Cl. CPC C08B 37/003

(57) ABSTRACT

The invention discloses a thiolated chitosan and a preparation method thereof, which is chitosan co-modified by hydroxybutyl and sulfhydryl. The preparation method includes the following steps: firstly, hydroxybutyl is introduced into a chitosan molecular chain, and then sulfhydryl is introduced as a sulfhydryl moiety by a condensation reaction between free amino of hydroxybutyl chitosan and carboxyl of L-cysteine. An aqueous solution of the thiolated chitosan of the invention is in a solution state at low temperature, and can be flow-injected. When the temperature rises to around 37° C., a hydrogel can be formed. Due to the introduction of sulfhydryl, the antioxidant ability and tissue adhesion ability of the material are increased. The thiolated chitosan prepared according to the method may have wide application prospects in an aspect such as tissue engineering, drug delivery systems, cell culture, cosmetics, etc.

### CROSS REFERENCES TO RELATED APPLICATION

This application claims priority of Chinese Patent Application No. 202111118987.3 filed on Sep. 24, 2021, the entire content of which are hereby incorporated by reference.

### FIELD OF THE INVENTION

The present invention is applied in the technical field of medical materials, and relates to a thiolated chitosan and a preparation method thereof.

### BACKGROUND OF THE INVENTION

Chitosan is the only alkaline polysaccharide among natural polysaccharides, and it is widely applied in food additives, textiles, agriculture, environmental protection, beauty and health care, cosmetics, antibacterial agents, medical fibers, medical dressings, artificial tissue materials, drug sustained-release materials, gene transfer vectors, biomedical fields, medical absorbable materials, tissue engineering vector materials, medicine, drug development and many other fields as well as other daily chemical industries. Hydroxybutyl chitosan is a derivative of chitosan, which is water-soluble and temperature-responsive. An aqueous solution of the hydroxybutyl chitosan has temperature sensitivity, and it is in a solution state at a low temperature, forming a gel at elevated temperature.

However, as a polymer with temperature sensitive gel-forming properties, the hydroxybutyl chitosan is limited in practical application by insufficient tissue adhesion and a poor antioxidant ability.

### SUMMARY OF THE INVENTION

The purpose of the invention is to provide a thiolated chitosan and a preparation method thereof. The thiolated chitosan prepared according to the method has good water solubility and temperature sensitivity, and may have wide application prospects in an aspect such as tissue engineering, drug delivery systems, cell culture, cosmetics, etc.

According to a first aspect of the purpose of the invention, the invention adopts the following technical solution.

A thiolated chitosan is characterized in that the thiolated chitosan is chitosan co-modified by hydroxybutyl and sulfhydryl. The thiolated chitosan can be expressed by the following formula:

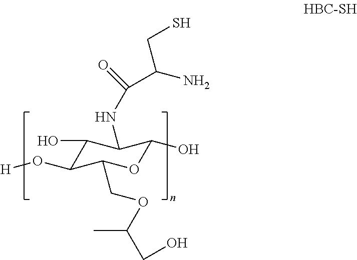

According to another aspect of the purpose of the invention, the invention adopts the following technical solution.

A preparation method of the above-mentioned thiolated chitosan comprises taking chitosan as a raw material, and synthesizing a thiolated chitosan by successively introducing a hydroxybutyl group and a sulfhydryl group, that is, thiolated hydroxybutylated chitosan HBC-SH. The specific steps are as follows. (1) Hydroxybutyl chitosan HBC is prepared. (2) The HBC is dissolved in an aqueous solution of acetic acid. 1-(3-dimethylaminopropyl)-3-ethylcarbodiimide hydrochloride EDC.HCl and N-hydroxysuccinimide NHS are added to the solution followed by stirring at room temperature in the dark. L-cysteine hydrochloride Cys.HCl is subsequently added followed by stirring at room temperature in the dark. The pH of the reaction liquid is adjusted to 4-6, and the reaction is performed at room temperature in the dark. (3) After the reaction is completed, dialysis is performed with purified water in the dark. The resulting dialysate is freeze-dried to obtain the thiolated chitosan.

The synthetic steps of the method can also be represented by the following formula:

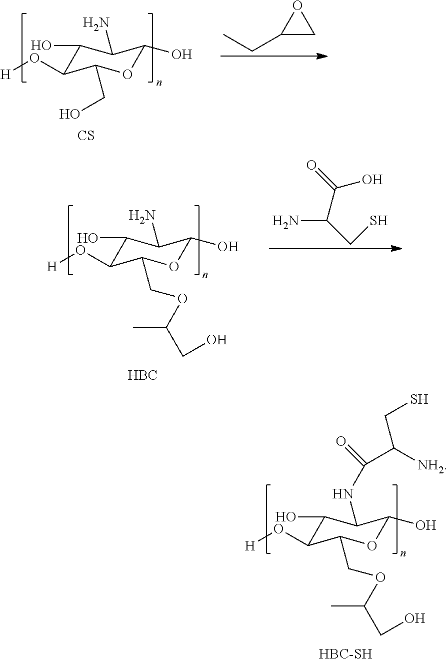

Further, in the step (2), the concentration of HBC is 0.01-10%.

Further, in the step (2), 1 M of sodium hydroxide is used to adjust the pH of the reaction liquid to 4-6.

Further, in the step (2), the reaction time is 4-48 h.

The key problem to be solved by the invention is how to give hydroxybutyl chitosan better tissue adhesion performance and antioxidant ability while retaining its temperature sensitivity. L-cysteine is a common amino acid in a living organism and is one of natural components of glutathione. Because its molecule contains active sulfhydryl (—SH), it has a protective effect on sulfhydryl protease and poisoned liver parenchyma cells, stimulates hematopoietic function, increases white blood cells and promotes the repair of skin damage. Using L-cysteine, the hydroxybutyl chitosan is converted into sulfhydryl-containing hydroxybutyl chitosan. This thiolated chitosan not only retains the temperature sensitivity of the original hydroxybutyl chitosan, but also increases the antioxidant ability and tissue adhesion ability of the material due to the introduction of sulfhydryl.

An aqueous solution of the thiolated chitosan of the invention is in a solution state at a low temperature, and can be flow-injected. When the temperature rises to around 37° C., a hydrogel can be formed. The invention can not only form an in-situ gel under physiological conditions, but also increase the antioxidative ability and tissue adhesion ability of the material due to the introduction of sulfhydryl. The thiolated chitosan prepared according to the method may have wide application prospects in an aspect such as tissue engineering, drug delivery systems, cell culture, cosmetics, etc.

The invention will be further described below with reference to the accompanying drawings and examples.

### BRIEF DESCRIPTION OF THE DRAWINGS

FIG. 1 is a photo of the temperature response test of a solution of chitosan HBC-SH co-modified by hydroxybutyl and sulfhydryl prepared according to the invention.

FIG. 2 is a broken line graph of the test results of the reducing ability of a solution of chitosan HBC-SH co-modified by hydroxybutyl and sulfhydryl prepared according to the invention.

### DETAILED DESCRIPTION OF THE EMBODIMENTS

In order to further understand the invention, the thiolated chitosan provided by the invention will be described in detail below with reference to examples, but the invention is not limited to these examples. Non-substantial improvement and adjustment made by those skilled in the art under the core guiding notion of the invention still belong to the protection scope of the invention.

(I) Preparation of a Thiolated Chitosan

### Example 1. Preparation of a Hydroxybutyl Chitosan HBC

(1) 20 g of chitosan was weighed, and was dissolved in 1000 ml of a 1% HCl aqueous solution followed by filtering. 1 mol/L of a NaOH solution was dropwise added to the filtrate to obtain a precipitate. The resulting precipitate was washed with distilled water until neutral. Desalination was performed with 70% ethanol. Dehydration was performed with 95% ethanol. A purified chitosan sample was obtained by drying at 50° C.

(2) 3 g of the purified chitosan was taken and dispersed in 30 ml of a 50% NaOH aqueous solution followed by stirring for 24 h and filtering. Excessive lye was squeezed out to obtain a solid. The obtained solid was added to 60 ml of an isopropanol aqueous solution (Vᵢₛₒₚᵣₒₚₐₙₒₗ:V_{water}=10:10) followed by stirring evenly. The temperature rose to 60° C. 80 ml of 1,2-epoxybutane was dropwise added, and the reaction was performed for 24 h. After cooling to room temperature, a 10% HCl aqueous solution was dropwise added to the reaction solution to adjust the pH of the system to neutrality. An insoluble substance was filtered off 3 times of the volume of ethanol was added to perform precipitation. Centrifugation, precipitation and drying were performed to obtain a hydroxybutyl chitosan HBC.

As for the preparation of hydroxybutyl chitosan HBC, reference can also be made to the preparation method disclosed in Chinese Patent 201110214776.X.

### Example 2. Preparation of a Thiolated Chitosan HBC-SH

0.5 g of the HBC prepared in Example 1 was accurately weighed, and was dissolved in 100 mL of a 0.05% acetic acid aqueous solution. 5 mmol of 1-(3-dimethylaminopropyl)-3-ethylcarbodiimide hydrochloride EDC.HCl and

N-hydroxysuccinimide NHS were added to the solution. Stirring was performed at room temperature for 0.5 h in the dark. 5 mmol of L-cysteine hydrochloride Cys.HCl was subsequently added. Stirring was performed at room temperature for 0.5 h in the dark. 1 M of sodium hydroxide was used to adjust the pH of the reaction liquid to 5, and the reaction was performed at room temperature for 24 h in the dark. After the reaction was completed, dialysis was performed with purified water in the dark for 3 days. The resulting dialysate was freeze-dried to obtain a thiolated chitosan HBC-SH-1.

### Example 3. Preparation of a Thiolated Chitosan HBC-SH

0.5 g of the HBC prepared in Example 1 was accurately weighed, and was dissolved in 100 mL of a 0.05% acetic acid aqueous solution. 5 mmol of 1-(3-dimethylaminopropyl)-3-ethylcarbodiimide hydrochloride EDC.HCl and N-hydroxysuccinimide NHS were added to the solution. Stirring was performed at room temperature for 0.5 h in the dark. 10 mmol of L-cysteine hydrochloride Cys.HCl was subsequently added. Stirring was performed at room temperature for 0.5 h in the dark. 1 M of sodium hydroxide was used to adjust the pH of the reaction liquid to 5, and the reaction was performed at room temperature for 24 h in the dark. After the reaction was completed, dialysis was performed with purified water in the dark for 3 days. The resulting dialysate was freeze-dried to obtain a thiolated chitosan HBC-SH-2.

### Example 4. Preparation of a Thiolated Chitosan HBC-SH

0.5 g of the HBC prepared in Example 1 was accurately weighed, and was dissolved in 100 mL of a 0.05% acetic acid aqueous solution. 5 mmol of 1-(3-dimethylaminopropyl)-3-ethylcarbodiimide hydrochloride EDC.HCl and N-hydroxysuccinimide NHS were added to the solution. Stirring was performed at room temperature for 0.5 h in the dark. 15 mmol of L-cysteine hydrochloride Cys.HCl was subsequently added. Stirring was performed at room temperature for 0.5 h in the dark. 1 M of sodium hydroxide was used to adjust the pH of the reaction liquid to 5, and the reaction was performed at room temperature for 24 h in the dark. After the reaction was completed, dialysis was performed with purified water in the dark for 3 days. The resulting dialysate was freeze-dried to obtain a thiolated chitosan HBC-SH-3.

(II) Temperature Response Test

Test method: A certain amount of HBC-SH-2 was weighed and dissolved in purified water at 4° C. to formulate a 5% HBC-SH-2 solution. The solution was placed at 4° C. and 37° C. many times.

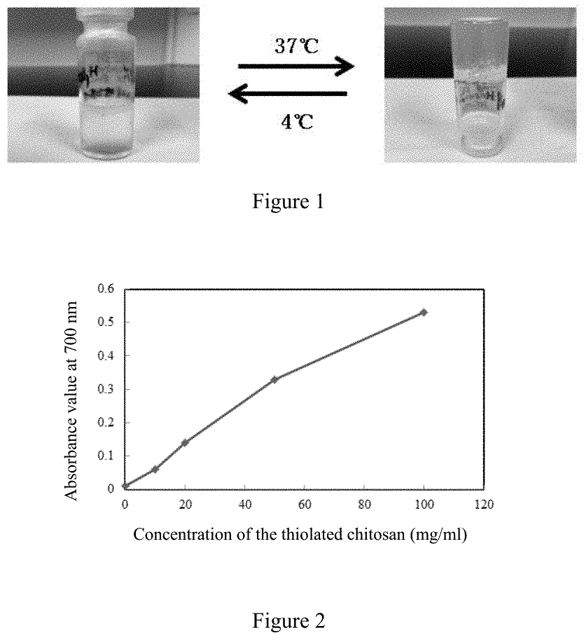

Conclusion: The results are shown in FIG. 1. The solution is a transparent solution at 4° C. and a transparent gel at 37° C. Moreover, the transition is reversible with temperature changes, indicating that the aqueous solution of the thiolated chitosan has temperature responsiveness.

(III) Sulfhydryl Content Test

Test method: The content of free sulfhydryl in thiolated chitosan was determined with an Ellman's reagent (DTNB) using the content of sulfhydryl demarcated by L-cysteine hydrochloride Cys.HCl as a standard curve.

Conclusion: The results are shown in the following table. The content of sulfhydryl in thiolated chitosan prepared according to different preparation methods is different to some extent.

| Sample No. | Sulfhydryl content |
|---|---|
| HBC-SH-1 | 0.0951 mmol/g |
| HBC-SH-2 | 0.1447 mmol/g |
| HBC-SH-3 | 0.1603 mmol/g |

(IV) Reducing Ability Test

Test principle: A sample with the reducing ability can reduce Fe′ of potassium ferricyanide to Fe′ (potassium ferrocyanide), and the Fe′ (potassium ferrocyanide) further generates Prussian blue {Fe₄[Fe(CN)₆}₃ with maximum absorbance at 700 nm under the reaction with ferric chloride.

Test method: 1) The thiolated chitosan (HBC-SH-3) samples with various concentrations was formulated with purified water, respectively 0 mg/ml, 10 mg/ml, 20 mg/ml, 50 mg/ml and 100 mg/ml. 2) 1 ml of each concentration sample was taken and put into a test tube. 2.5 ml of a potassium ferricyanide solution [K₃Fe(CN)₆, 1%], and 2.5 ml of sodium phosphate buffer (0.2 M, pH 6.6) were added successively. After mixing evenly, the mixture was incubated at 50° C. for 20 min. Then 2.5 ml of trichloroacetic acid (10%) and 0.5 ml of ferric chloride (FeC1₃, 0.1%) were added successively. The absorbance value of the mixture was measured at 700 nm.

Conclusion: The results are shown in FIG. 2. The thiolated chitosans with different concentrations have absorbance values at 700 nm after treatment, indicating that the sulfhydryl modified hydroxybutyl chitosan exhibits a certain reducing ability.

1. A thiolated chitosan, wherein the thiolated chitosan is a chitosan co-modified by hydroxybutyl and sulfhydryl.
